(19) United States
(12) Patent Application Publication
(10) Pub. No.: US 2003/0215372 A1
(43) Pub. Date: Nov. 20, 2003

(54) Particle filter with an electric heater and production process for such a particle filter

(75) Inventors: Lutz Ose, Sternenfels (DE); Christian Seidler, Bretten (DE)

Correspondence Address: AKERMAN SENTERFITT, P.O. BOX 3188, WEST PALM BEACH, FL, 33402-3188, US

(73) Assignee: E.G.O. Elektro-Geraetebau GmbH, Oberderdingen (DE)

(21) Appl. No.: 10/427,379

(22) Filed: May 1, 2003

(30) Foreign Application Priority Data
May 16, 2002 (DE) DE 102 23 148.6

(51) Int. Cl. F01N 3/10; B01D 53/34

(52) U.S. Cl. 422/174; 422/171; 422/177

(57) ABSTRACT

A carbon black filter (23) is provided which has a heater (17) for burning deposited carbon black. The particle filter (23) has several filter surfaces (12), which carry catalyst coatings (21), which cover a small part of the filter surface. The catalyst coatings (21) are constructed for bringing about an oxidation of carbon black at a lower temperature than the ignition temperature of the carbon black. Combustion is initiated by the heater (17).

### FIELD OF APPLICATION AND PRIOR ART

The invention relates to a particle filter with an electric heater for the combustion of deposited particles, as well as a corresponding production process for such a particle filter. Particle filters usually have a filter surface or filter element on which particles are deposited. The invention is preferably used for a carbon black filter, such as may be used in diesel engines.

In the case of particle filters the problem generally arises that the filter elements become clogged with the filtered out particles. This problem is particularly serious for diesel filters. A clogged filter loses its filtering action and at the same time the exhaust gas removal is impaired, which leads to an increased exhaust gas dynamic pressure and can lead to the diesel engine operating in a less satisfactory manner.

It has been proposed that a particle filter has several filter elements between which are located disk-shaped, foil-like heating elements. By means of the heating elements, at intervals or continuously the filter can be burnt free, particularly of carbon black. However, the problem arises that it is necessary to reach a temperature of approximately 700° C. for the combustion process. This firstly seriously thermally stresses the filter and secondly electric power consumption is considerable.

Problem and Solution

The problem of the invention is to provide a filter of the aforementioned type, which is able to avoid the problems of the prior art and which in particular permits a combustion of deposited particles at a lower temperature and with a lower power consumption.

This problem is solved by a particle filter having the features of claim 1. Advantageous and preferred developments of the invention form the subject matter of the further claims and are explained in greater detail hereinafter. By express reference the wording of all the claims is made into part of the content of the present description.

According to the invention a particle filter has a filter surface or a filter element, which carries on part of its surface area a catalytically active coating. This coating is suitable for the oxidation or combustion of particles. Said particles are in particular carbon black or in general particles occurring during the combustion of fuel in internal combustion engines.

This makes it possible to burn carbon black deposited on the filter element at lower temperatures, which is brought about by the catalytic action. There is also only a reduction to part of the surface area of the filter element and consequently the filtering action. The process of burning carbon black on a filter with catalyst support is known from the prior art and need not be described in greater detail here. As a result of such a catalytically active coating it is possible to reduce the ignition temperature of carbon black from above 700° C. to somewhat above 500° C., e.g. 520° C. to 540° C.

The coating can be formed in several different ways. It is advantageously applied directly as a coating to the filter element. With particular advantage it can be applied in a permanently adhering form. In particular, according to a possibility of the invention, part of the filter element surface is coated. The coating advantageously covers a cohesive surface area.

In order to attain an advantageous ratio between catalyst action and existing filtering action, the catalyst coating can cover up to 30% of the filter element surface. Preferably the proportion is smaller, especially approximately 15%.

Numerous materials can be used for the catalytic action material. The coating advantageously contains platinum or palladium, because these have a very good catalytic action. It is also possible to produce the coating with a mixture of at least one of these two materials.

For the catalyst action particular importance is obtained to the surface area or surface action of the catalytically active coating. Thus, the coating thickness can be made relatively small, so that both weight and valuable material are economized. A possible coating thickness is in the micrometer range between 1 μm and 5 μm, advantageously between 2 μm and 8 μm, for example 4 μm.

In a preferred development of the invention the coating is placed in spatial proximity to the electric heater. Thus, it is possible through the double action of the heating system and the catalyst support to at least in one area initiate carbon black combustion. This can propagate in the manner of a surface burning off of the areas of the filter element having no catalyst coating. Once an exothermic process has started through the combustion of the carbon black, the carbon black in the vicinity is also burned. In particularly preferred manner a catalytically active coating is in the area of the filter element closest to the heater.

The shape of the catalyst coating corresponds or is similar to the shape of the heater. Preferably the heater is linear and the extension or arrangement of the coating is based on the heater shape. In preferred manner it follows entirely or partly a linear shape. For an improved surface action the coating can be slightly wider than the heater.

A preferred particle filter can have several filter elements, which greatly increases the total surface area of the particle filter. Each filter element has at least one catalytically active coating.

In particularly advantageous manner the filter elements in each case have two and in specific cases also more surfaces and they can be disk-shaped, for example. Very advantageously each of the surfaces of a filter element has its own catalyst coating. Thus, for each individual surface of a filter element, the combustion of carbon black can be assisted by the catalyst.

It is also possible to create a particle filter having several filter surfaces folded in bellows-like manner. The filter can be elongated and cylindrical.

The invention also covers a process for the production of a particle filter having the features of claim 16. According to the invention, the catalytically active coating is applied as a thick film paste with a corresponding surface shape to a filter element and following application the coating is burnt in.

The method for applying the thick film paste to a filter element surface is advantageously on the one hand a spraying process and on the other a silk screen process. The thick film paste is advantageously a so-called resinate paste. However, other thick film pastes can also be used.

These and further features of preferred developments of the invention can be gathered from the claims, description and drawings and the individual features, both individually and in the form of sub combinations, can be implemented in an embodiment of the invention and in other fields and can represent advantageous, independently protectable constructions for which protection is claimed here.

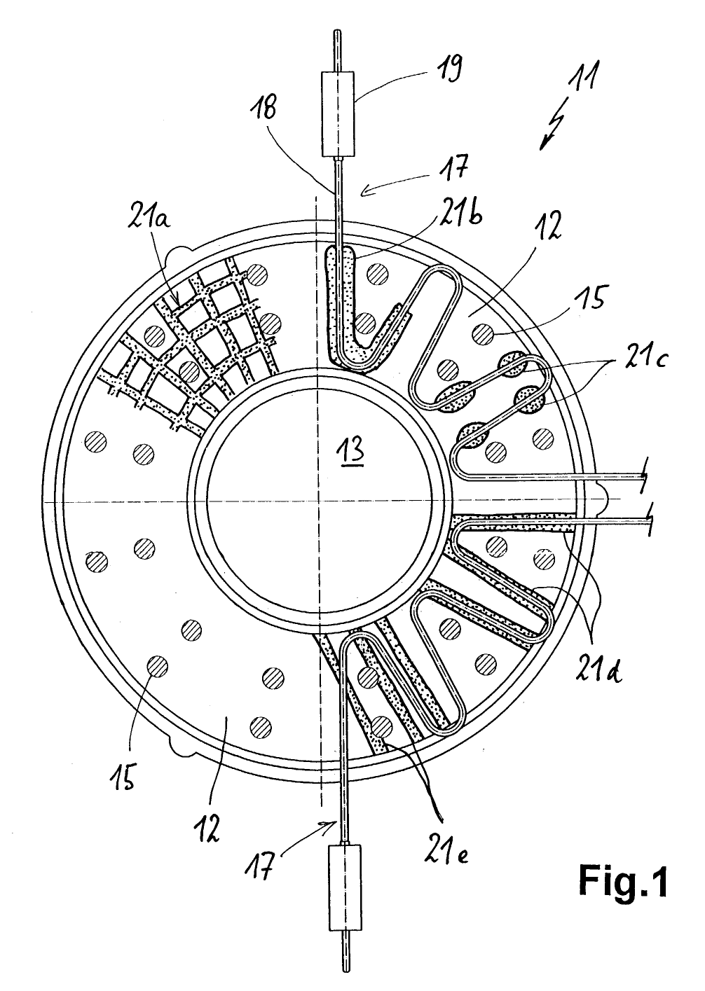

An embodiment of the invention is described hereinafter relative to the attached FIG. 1, which is a plan view of a disk-shaped filter element with a meander-shaped heater and differently constructed flat catalyst coatings.

### DETAILED DESCRIPTION OF THE EMBODIMENT

FIG. 1 shows in substantially diagrammatic manner a filter element 11 in the form of a disk. More specifically the filter element is a type of circular disk with a circular filter surface 12 and an inner area 13. The filter element 11 also has junction points 15 shown in hatched form. By means of said junction points 15, two filter elements 11 can be joined to form a double disk. Alternatively and/or additionally the junction points 15 can serve as spacers between two filter elements. Such filter elements 11 can e.g. be constructed in the above-described manner as double disks.

Over the filter surface 12 passes a heater 17 and for facilitating understanding it is only shown here for the right-hand area of the filter element 11. It would normally pass over and beyond the entire filter surface 12. In this specific case the heater 17 has a meander-shaped heating coil 18 with attachment plugs or connectors 19 and can e.g. be manufactured as a thin tubular heater. Such a heater is disclosed in DE 101 27 223 and for more specific details express reference is made to said patent application.

In the embodiment shown a heater 17 is provided in each quadrant. It is obviously possible to construct heaters in some other shape or form. For example, it is possible to have a flat heater, e.g. with flat heater foils.

The filter surface 12 carries catalyst coatings 21 shown in dotted line form. Several different catalyst coating constructions are shown.

21a designates a catalyst coating constructed in the manner of a lattice. This permits a relatively good covering of the entire filter surface 12 with such a catalyst coating 21a.

21b is a catalyst coating precisely following the path of the heating coil 18. It is slightly wider than the heating coil 18 or the projection thereof on the filter surface 12. This is intended to show that a catalyst coating can precisely follow a heater with a specific, predetermined shape.

21c indicate catalyst coatings in the form of individual spots or spot-like areas. As can be seen, they are arranged in accordance with the course of the heating coil 18. However, it is also conceivable to distribute them in a more or less uniform manner over the filter surface independently of the heater course.

21d relate to catalyst coatings which in each case pass roughly radially and at right angles over a filter surface 12 in the manner of spokes. Their path is similar to the catalyst coating 21b. However, they can also have a spoke-like arrangement independently of the course of a heater.

21e are catalyst coatings covering the filter surface 12 in the manner of a line pattern. Their course or arrangement can also be chosen independently of the heater shape.

With regards to the distributions for catalyst coatings 21 shown, constructions 21b, 21c and 21d are considered advantageous particularly when using heating coils 18. As stated hereinbefore, it is possible to construct them very close to the heater 17 and therefore ensure that the carbon black ignition temperature is reached relatively rapidly.

It is obviously possible for the paths of the catalyst coatings 21 to be made narrower. However, this is firstly dependent on the application process and secondly, as FIG. 1 is of a diagrammatic nature, they are shown somewhat wider here to make representation easier.

Thus, according to an embodiment of the invention a carbon black filter can be obtained, which has a heater for burning deposited carbon black. The particle filter has several filter surfaces. The filter surfaces carry catalyst coatings, which cover a small part of the filter surface. The catalyst coatings serve to bring about an oxidation of carbon black at a lower temperature than the ignition temperature. Combustion is initiated by the heater.

A carbon black filter may be provided which has a heater for burning deposited carbon black. The particle filter has several filter surfaces, which carry catalyst coatings, which cover a small part of the filter surface. The catalyst coatings are constructed for bringing about an oxidation of carbon black at a lower temperature than the ignition temperature of the carbon black. Combustion is initiated by the heater.

1. Particle filter with a heater for the combustion of particles deposited on said particle filter, wherein said particle filter has at least one filter surface, wherein part of said filter surface has a catalytically active coating, wherein said catalytically active coating is suitable for oxidizing part of said particles, such as carbon black or the like, at lower temperatures.

2. Particle filter according to claim 1, wherein a part of said filter surface with said catalytically active coating is located on a filter element.

3. Particle filter according to claim 2, wherein said filter element comprises said filter surface.

4. Particle filter according to claim 2, wherein said catalytically active coating covers said part of said filter element surface.

5. Particle filter according to claim 1, wherein said catalytically active coating covers between 1% and 30% of said filter surface.

6. Particle filter according to claim 1, wherein said catalytically active coating contains platinum or palladium.

7. Particle filter according to claim 6, wherein said catalytically active coating contains a mixture with one of said materials platinum or palladium.

8. Particle filter according to claim 1, wherein said catalytically active coating thickness is between 1 μm and 50 μm.

9. Particle filter according to claim 8, wherein said catalytically active coating thickness is between 2 μm and 8 μm.

10. Particle filter according to claim 1, wherein said catalytically active coating is in spatial proximity to said heater.

11. Particle filter according to claim 10, wherein said catalytically active coating is provided at said filter surface point closest to said heater.

12. Particle filter according to claim 1, wherein there are provided several said filter elements with several said filter surfaces in said particle filter, wherein each said filter element comprises at least one said catalytically active coating.

13. Particle filter according to claim 12, wherein said filter elements in each case have at least two or more said filter surfaces.

14. Particle filter according to claim 13, wherein said filter elements are disk-shaped and each of said several filter surfaces of said filter element has one of said catalytically active coatings for its own.

15. Particle filter according to claim 1, wherein said heater is an electric heater.

16. Process for the production of said particle filter according to claim 1, wherein said catalytically active coating is applied from a corresponding starting material to said filter surface in the form of a thick film paste, wherein said thick film paste is zonally applied and subsequently is burnt in.

17. Process according to claim 16, wherein said thick film paste is applied to said filter surface by spraying or screen printing.

18. Process according to claim 16, wherein said thick film paste is a resinate paste.
